(19) United States
(12) Patent Application Publication
(10) Pub. No.: US 2023/0170654 A1
(43) Pub. Date: Jun. 1, 2023

(54) CONNECTOR AND CONNECTOR MANUFACTURING METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Pipatthana PHATIWUTTIPAT, Mie (JP); Kenji MAKINO, Mie (JP)

(21) Appl. No.: 17/922,099

(22) PCT Filed: Apr. 12, 2021
(86) PCT No.: PCT/JP2021/015122

§ 371 Date: Oct. 28, 2022

(30) Foreign Application Priority Data
May 1, 2020 (JP) 2020-080897

(51) Int. Cl. H01R 24/60; H01R 43/02; H01R 13/502

(52) U.S. Cl. CPC H01R 24/60; H01R 43/0256; H01R 13/502; H01R 2107/00

(57) ABSTRACT

A connector is provided with a plurality of terminal fittings (10), a holding member (20) configured such that the plurality of terminal fittings (10) are arranged in parallel therein, a circuit board (90) to which the plurality of terminal fittings (10) are connected, and a housing (50) for holding the holding member (20). The connector is manufactured by successively performing an arranging step of arranging the plurality of terminal fittings (10) in parallel in the holding member (20), a reflow step of reflow-connecting the plurality of terminal fittings (10) to the circuit board (90) and a holding step of holding the holding member (20) in the housing (50).

### TECHNICAL FIELD

The present disclosure relates to a connector and a connector manufacturing method.

### BACKGROUND

A connector described in Patent Document 1 is provided with a plurality of terminal fittings to be connected to a flexible printed board (hereinafter, referred to as a circuit board) and a housing for accommodating the respective terminal fittings. The terminal fitting includes a tip-side connecting portion and a board-side connecting portion. The tip-side connecting portion is connected to a mating terminal. The board-side connecting portion is connected to a wiring pattern of the circuit board.

### PRIOR ART DOCUMENT

### Patent Document

Patent Document 1: JP 2020-021595 A

### SUMMARY OF THE INVENTION

### Problems to be Solved

If connected positions of the board-side connecting portions to the wiring pattern of the circuit board are not aligned in the respective terminal fittings, the tip positions of the tip-side connecting portions are also not aligned at a fixed position and the respective terminal fittings may not be properly accommodated into the housing. On the other hand, if the connected positions of the board-side connecting portions of the respective terminal fittings to the wiring pattern of the circuit board are strictly managed, a problem of deteriorating workability occurs.

Accordingly, the present disclosure aims to provide a connector enabling easy position management of each terminal fitting and capable of improving workability.

### Means to Solve the Problem

The present disclosure is directed to a connector with a plurality of terminal fittings, a holding member configured such that the plurality of terminal fittings are arranged in parallel therein, a circuit board, the plurality of terminal fittings being connected to the circuit board, and a housing for holding the holding member.

### Effect of the Invention

According to the present disclosure, it is possible to provide a connector enabling easy position management of each terminal fitting and capable of improving workability.

### BRIEF DESCRIPTION OF THE DRAWINGS

FIG. 1 is a section of a connector in an embodiment.

FIG. 2 is a section of an intermediate unit.

FIG. 3 is a perspective view showing a state where a plurality of terminal fittings are inserted in respective cavities of a holding member.

FIG. 4 is a perspective view showing a state where board connecting portions of the plurality of terminal fittings are placed on respective electrically conductive portions of a circuit board.

FIG. 5 is a perspective view showing a state where the board connecting portions of the plurality of terminal fittings are reflow-connected to the respective electrically conductive portions of the circuit board to form the intermediate unit.

FIG. 6 is a perspective view showing a state where the intermediate unit is incorporated into a first housing member.

FIG. 7 is a perspective view showing a state where a second housing member is mounted on the first housing member.

FIG. 8 is a perspective view of the completely assembled connector.

FIG. 9 is a bottom view of a front part of the connector.

### DETAILED DESCRIPTION TO EXECUTE THE INVENTION

### Description of Embodiments of Present Disclosure

First, embodiments of the present disclosure are listed and described.

(1) The connector of the present disclosure is provided with a plurality of terminal fittings, a holding member configured such that the plurality of terminal fittings are arranged in parallel therein, a circuit board, the plurality of terminal fittings being connected to the circuit board, and a housing for holding the holding member. According to this configuration, the plurality of terminal fittings are arranged in parallel in the holding member, whereby the tip positions of the respective terminal fittings can be properly aligned. By connecting the respective terminal fittings to the circuit board in that state, relative position shifts of the respective terminal fittings can be prevented. Thus, the tip positions of the respective terminal fittings can be properly maintained with the holding member held in the housing. As described above, since the positions of the respective terminal fittings can be collectively managed by the holding member in this configuration, cumbersome position management is not necessary and workability can be improved.

(2) Preferably, the terminal fitting includes a board connecting portion to be connected to the circuit board and a body portion arranged forward of the board connecting portion, and the holding member holds the body portion in front of the board connecting portion. According to this configuration, the presence of the holding member does not hinder the connection of the board connecting portions to the circuit board. Further, the enlargement of the holding member can be avoided.

(3) The housing may include a first housing member and a second housing member, and the holding member may be sandwiched and held between the first housing member and the second housing member. According to this configuration, the holding member can be stably held and the circuit board can be sandwiched between the first and second housing members. Further, a special member for holding the holding member in the housing is not necessary and the complication of an overall structure can be avoided.

(4) The holding member may be made of a material higher in heat resistance than the housing. According to this configuration, the holding member can withstand heating in a reflow step, for example, when the respective terminal fittings are reflow-connected to the circuit board while being arranged in parallel in the holding member.

(5) A connector manufacturing method for the connector described above is provided with an arranging step of arranging the plurality of terminal fittings in parallel in the holding member, a reflow step of reflow-connecting the plurality of terminal fittings to the circuit board, and a holding step of holding the holding member in the housing, the steps being successively performed. According to this manufacturing method, when the plurality of terminal fittings are reflow-connected to the circuit board, the holding member can prevent relative position shifts of the respective terminal fittings. As a result, the tip positions of the respective terminal fittings can be aligned at a fixed position when the holding member is held in the housing.

### Details of Embodiment of Present Disclosure

A specific example of a connector according to an embodiment of the present disclosure is described below with reference to the drawings. Note that the present invention is not limited to this illustration and is intended to be represented by claims and include all changes in the scope of claims and in the meaning and scope of equivalents.

The connector is provided with a plurality of terminal fittings 10, a circuit board 90, a holding member 20 and a housing 50. The housing 50 is composed of dividable first housing member 51 and second housing member 52.

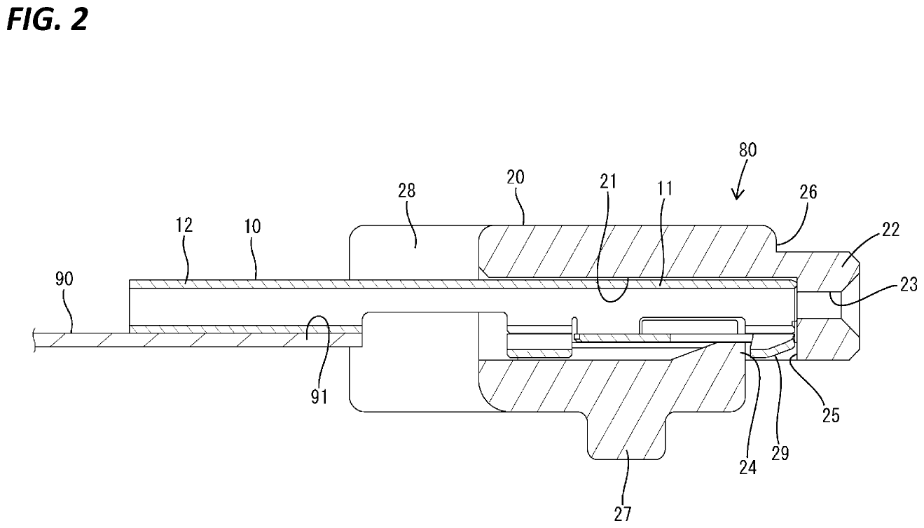

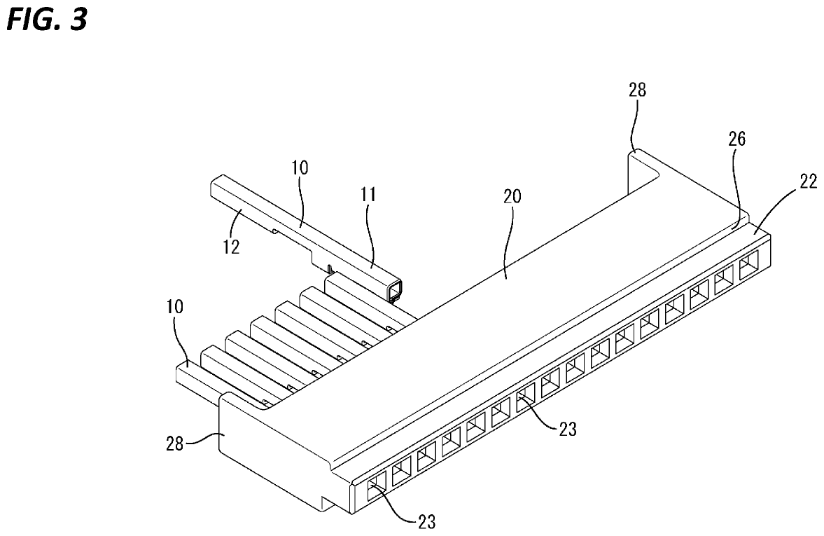

The terminal fitting 10 is formed, such as by bending an electrically conductive metal plate. As shown in FIGS. 2 and 3, the terminal fitting 10 includes a tubular body portion 11 in a front part (right part in FIGS. 2 and 3). The terminal fitting 10 includes a tubular or strip-like board connecting portion 12 long in a front-rear direction behind the body portion 11. The board connecting portion 12 is placed on and soldered to a later-described electrically conductive portion 91 (land) of the circuit board 90. The terminal fitting 10 is reflow-connected to the circuit board 90 via the board connecting portion 12. Note that reflow connection means that solder paste is melted by being heated in a reflow device (reflow furnace) and electrically connects each electrically conductive portion 91 of the circuit board 90 and each terminal fitting 10.

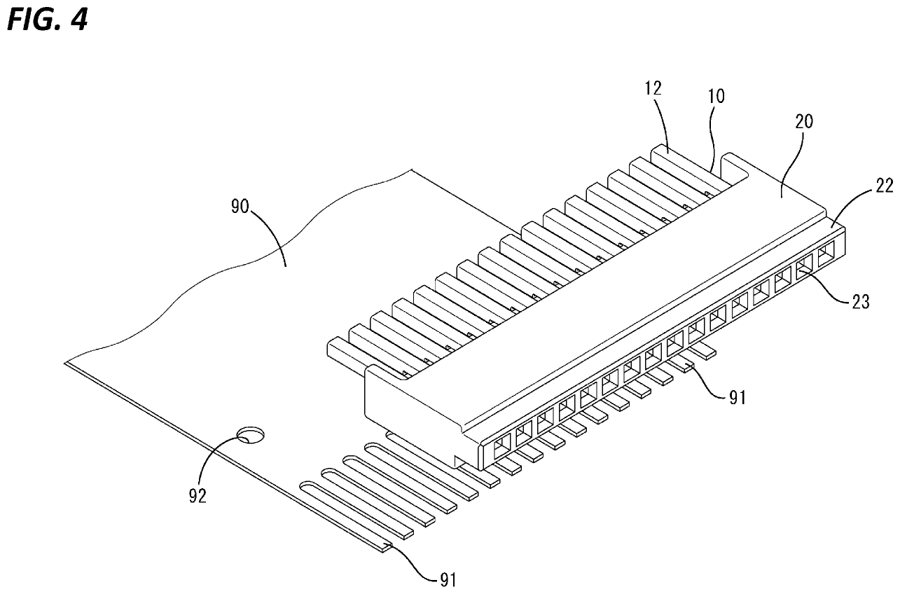

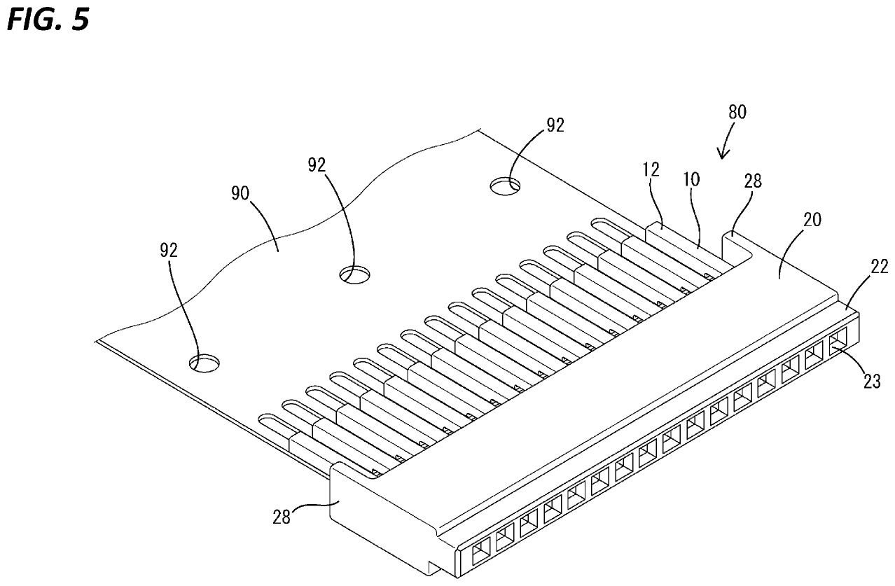

The circuit board 90 is a flexible printed board and in the form of a sheet rectangular in a plan view as shown in FIGS. 4 and 5. A front part of the circuit board 90 is held in the housing 50. A plurality of the electrically conductive portions 91 are provided to project like comb teeth in the front part of the circuit board 90. The respective electrically conductive portions 91 are arranged side by side in a width direction.

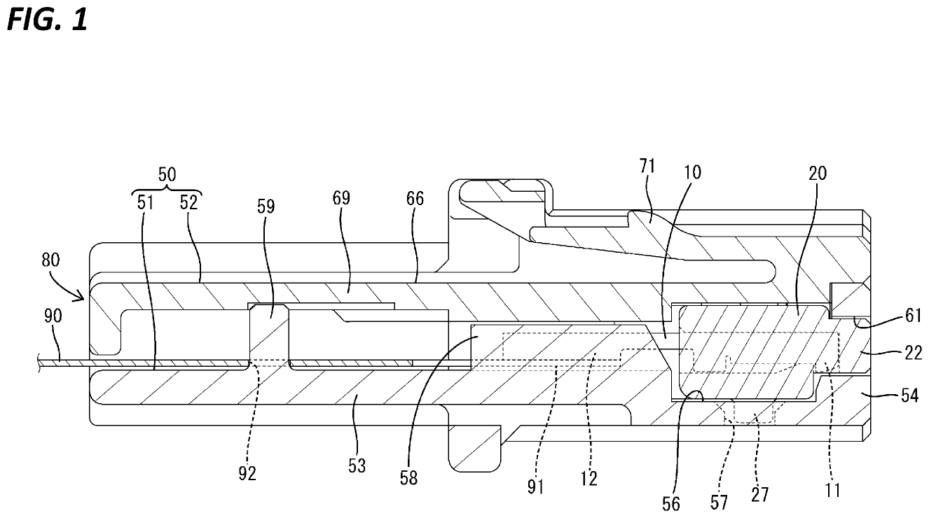

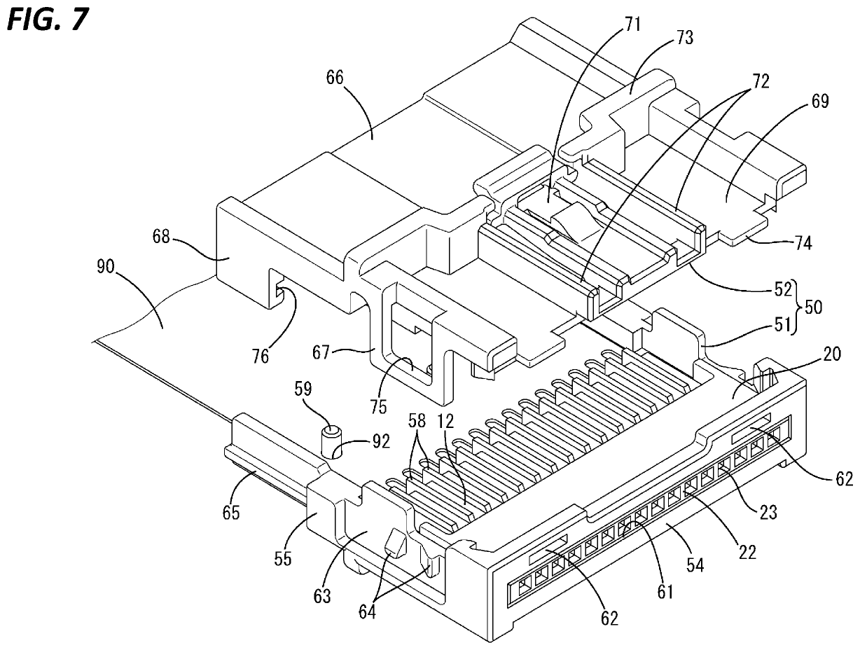

Solder paste is applied to the upper surfaces of the respective electrically conductive portions 91 to extend in a strip-like manner in the front-rear direction. A plurality of locking holes 92 are provided behind the respective electrically conductive portions 91 while being laterally spaced apart. Later-described locking pins 59 of the first housing member 51 are inserted into the respective locking holes 92 (see FIGS. 1 and 7).

The holding member 20 is made of heat resistant synthetic resin such as liquid crystal polymer, PPS (polyphenylene sulfide) resin or PEEK (polyether ether ketone) resin. The holding member 20 is formed to be long in a lateral direction and flat in a vertical direction.

The holding member 20 is provided with a plurality of cavities 21. The respective cavities 21 are arranged laterally side by side inside the holding member 20. As shown in FIG. 2, the cavity 21 extends in the front-rear direction and has a rear end open in the rear surface of the holding member 20 and a front end closed by a front wall portion 22 of the holding member 20. A plurality of tab insertion holes 23 are provided to penetrate through the front wall portion 22 of the holding member 20. The respective tab insertion holes 23 communicate with the respective cavities 21.

The holding member 20 includes a plurality of locking projections 24 on the lower surfaces of inner walls of the respective cavities 21. As shown in FIG. 2, the locking projection 24 is claw-like and projects into the cavity 21. The locking projection 24 is rigid to maintain a certain shape without being resiliently deformed so that the locking projection 24 is not deformed by heating in a reflow step. The front surface of the locking projection 24 extends in the vertical direction and is arranged to form a step together with the lower surface of the holding member 20. An opening 25 communicating with the respective cavities 21 is provided in the lower surface of the holding member 20. The front surface of the locking projection 24 defines the rear end of the opening 25.

The body portion 11 of the terminal fitting 10 is inserted into each cavity 21 from behind. The locking projection 24 faces a locking claw 29 provided on the lower surface of the body portion 11 and locks the body portion 11. The terminal fitting 10 is retained and held in the holding member 20 via the locking projection 24. The locking claw 29 enters the opening 25 to be arranged.

A tab of an unillustrated mating terminal fitting is inserted into each tab insertion hole 23. The tab of the mating terminal fitting is inserted into the body portion 11 through the tab insertion hole 23, contacts an electrically conductive part in the body portion 11 and is electrically connected to the terminal fitting 10.

The upper and lower surfaces of the holding member 20 are arranged flat in the lateral direction. The upper and lower surfaces of the holding member 20 include steps 26 at positions including the front surfaces of the locking projections 24. The front wall portion 22 of the holding member 20 is a part forward of the steps 26 and is formed thinner (has a smaller vertical dimension) than a rear part.

A plurality of protrusions 27 are provided on the lower surface of the holding member 20. The respective protrusions 27 have a cylindrical shape and are spaced apart in a width direction. A pair of projecting walls 28 projecting rearward are provided on both left and right ends of the holding member 20. Coupling parts between the body portions 11 and the board connecting portions 12 in the respective terminal fittings 10 are arranged between the both projecting walls 28 and protected by the both projecting walls 28 (see FIG. 5).

The first housing member 51 is made of synthetic resin such as PBT (polybutylene terephthalate) lower in heat resistance than the holding member 20. The first housing member 51 is arranged below the second housing member 52. The first housing member 51 constitutes a lower part of the housing 50.

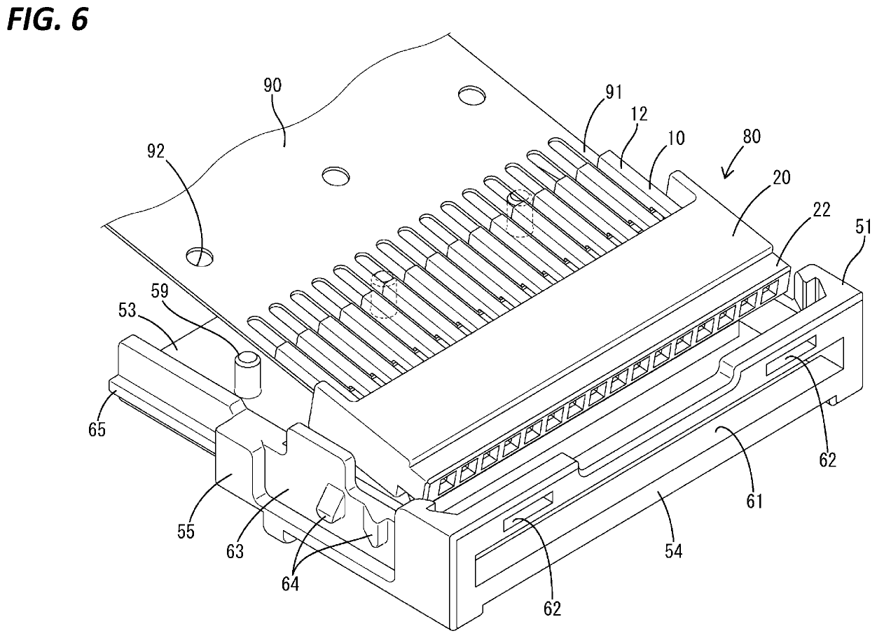

As shown in FIG. 6, the first housing member 51 includes a bottom wall 53 in the form of a rectangular flat plate, a front wall 54 rising from the front end of the bottom wall 53 and a pair of side walls 55 rising from both left and right ends of the bottom wall 53. The respective electrically conductive portions 91 of the circuit board 90 and the holding member 20 are placed on the upper surface of the bottom wall 53. As shown in FIG. 1, a recess 56 is provided in a front part of the upper surface of the bottom wall 53. The front surface and a lower part of the rear surface of the recess 56 are arranged along the vertical direction. An upper part of the rear surface of the recess 56 is formed on partition walls 58 to be described later, and arranged obliquely downward toward the front.

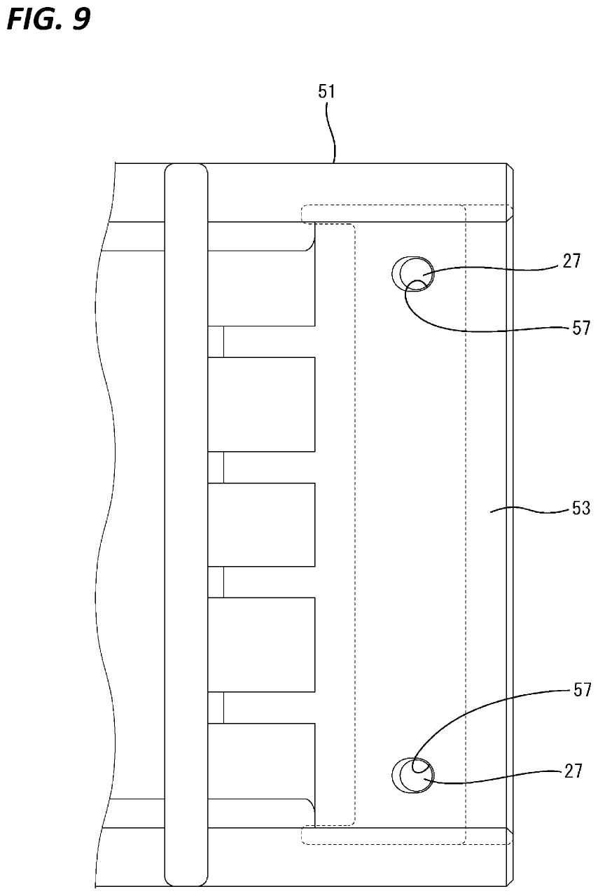

The bottom wall 53 is provided with a plurality of retaining holes 57 vertically penetrating at positions corresponding to the respective protrusions 27. The upper ends of the respective retaining holes 57 are open to the recess 56. A lower end part of the holding member 20 is fit into the recess 56. The protrusions 27 are loosely inserted into the retaining holes 57 as shown in FIG. 9. The step 26 of the holding member 20 is arranged to face the front surface of the recess 56. The rear surface of the holding member 20 is arranged to face the rear surface of the recess 56. Both left and right end surfaces of the holding member 20 are arranged to face the both side walls 55. The holding member 20 is movable in the front-rear direction in a state where the holding member 20 is fit in the recess 56 and the protrusions 27 are inserted in the retaining holes 57.

As shown in FIG. 7, a plurality of the partition walls 58 are provided behind the recess 56 to project on the upper surface of the bottom wall 53. The respective partition walls 58 extend in the front-rear direction and are arranged laterally side by side on the upper surface of the bottom wall 53. The respective partition walls 58 are arranged between the respective electrically conductive portions 91. The laterally adjacent electrically conductive portions 91 and board connecting portions 12 are partitioned by the partition walls 58. A plurality of the locking pins 59 are provided behind the respective partition walls 58 on the upper surface of the bottom wall 53. The respective locking pins 59 have a cylindrical shape and are arranged at intervals in the width direction.

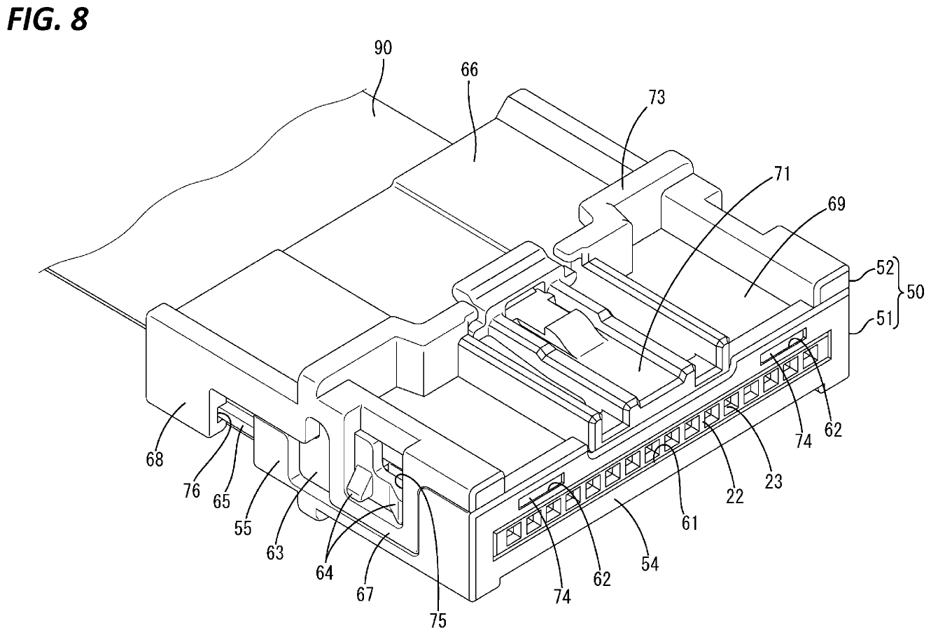

As shown in FIG. 6, the front wall 54 is provided over an entire length in the lateral direction in the first housing member 51. One fitting hole 61 long in the lateral direction is provided to penetrate through the front wall 54 in the front-rear direction. As shown in FIGS. 1 and 7, the front wall portion 22 of the holding member 20 is fit into the fitting hole 61. The respective tab insertion holes 23 of the holding member 20 are arranged to be located in the front surface of the front wall 54. A pair of insertion holes 62 are provided to penetrate through the front wall 54 in the front-rear direction at both left and right side positions above the fitting hole 61. The insertion hole 62 has a shape elongated in the lateral direction. As shown in FIG. 8, later-described inserting portions 74 of the second housing member 52 are fit into the insertion holes 62.

As shown in FIG. 6, recesses 63 are provided in the outer surfaces of front parts of the both side walls 55, and a plurality of lock portions 64 are provided on the back surface of each recess 63. The respective lock portions 64 are arranged side by side in the front-rear direction on the back surface of the recess 63. The respective lock portions 64 are fit into lock holes 75 of later-described lock pieces 67 of the second housing member 52. Rear parts of the both side walls 55 are formed thinner than the front parts. Ribs 65 extending in the front-rear direction are provided on the outer surfaces of the rear parts of the both side walls 55.

The second housing member 52 is made of the same synthetic resin as the first housing member 51. The second housing member 52 constitutes an upper part of the housing 50. As shown in FIGS. 7 and 8, the second housing member 52 includes a covering wall 66 for covering the first housing member 51 from above, a pair of the lock pieces 67 projecting downward from both left and right ends of a front part of the covering wall 66 and a pair of holding pieces 68 projecting downward from both left and right ends of a rear part of the covering wall 66. The covering wall 66 includes a body wall 69 in the form of a rectangular plate, a lock arm 71 projecting from the outer surface of a front part of the body wall 69, a pair of extending walls 72 covering both left and right sides of the lock arm 71 and a rib-like crossing wall 73 extending in the lateral direction behind the lock arm 71. A pair of the inserting portions 74 are provided to project on both left and right sides across the lock arm 71 and the respective extending walls 72 on the front end of the body wall 69. The inserting portion 74 is in the form of a rib along the lateral direction and formed into a size fittable into the insertion hole 62.

The lock arm 71 has a shape cantilevered rearward from a base end part connected to a laterally central part of the upper surface of the body wall 69. The lock arm 71 is deflectable and deformable in the vertical direction with the base end part as a fulcrum. The lock arm 71 locks an unillustrated mating housing as a connection partner of the housing 50 and holds the housing 50 and the mating housing in a connected state.

Each lock piece 67 is in the form of a rectangular frame and includes the lock hole 75 inside. Each lock piece 67 is deflectable and deformable in the lateral direction (in-out direction) with an upper end part connected to the covering wall 66 as a fulcrum. The holding piece 68 is in the form of a rectangular plate piece and includes a groove portion 76 extending in the front-rear direction on the lower end of an inner surface.

Next, a manufacturing method (assembly method) of the connector of this embodiment is specifically described.

As a terminal insertion step, the plurality of terminal fittings 10 are inserted into the respective cavities 21 of the holding member 20 as shown in FIG. 3. The respective terminal fittings 10 are locked by the locking projections 24 and held in the holding member 20 while being arranged in parallel (aligned) in the width direction. In this case, the tips of the respective terminal fittings 10 are arranged in alignment at the same position in the front-rear direction by contacting the front wall portion 22 of the holding member 20. The board connecting portions 12 of the respective terminal fittings 10 are exposed rearward behind the rear surface of the holding member 20.

Subsequently, as a reflow step, the board connecting portions 12 of the respective terminal fittings 10 are placed on the solder paste on the respective electrically conductive portions 91 of the circuit board 90 and the solder paste is heated and melted in the unillustrated reflow device (reflow furnace) as shown in FIG. 4. In this way, the board connecting portions 12 of the respective terminal fittings 10 are soldered and connected to the respective electrically conductive portions 91. The respective protrusions 27 of the holding member 20 are fit and positioned in holes of an unillustrated receiving plate of the reflow device. Since the body portions 11 are held by the holding member 20, the respective terminal fittings 10 are prevented from being shifted in position from each other during heating. After the completion of the reflow step, the intermediate unit 80 in which the circuit board 90, the respective terminal fittings 10 and the holding member 20 are integrated (integrally handleable) is formed as shown in FIGS. 2 and 5.

Subsequently, as a housing setting step, a lower end part of the holding member 20 of the intermediate unit 80 is fit into the recess 56 of the first housing member 51 as shown in FIG. 6. In the process of fitting the holding member 20 into the recess 56, the lower end part of the holding member 20 slides along an inclined region of the upper part of the rear surface of the recess 56 and is inserted into the recess 56. The lower end part of the holding member 20 abuts on the front surface of the recess 56, a rear part of the intermediate unit 80 is displaced downward, and the respective locking pins 59 of the first housing member 51 are fit into the respective locking holes 92 of the circuit board 90. Simultaneously, the front wall portion 22 of the holding member 20 is also fit into the fitting hole 61 of the first housing member 51. The intermediate unit 80 is held on the first housing member 51 with separation restricted by fitting the lower end part of the holding member 20 into the recess 56, fitting the front wall portion 22 of the holding member 20 into the fitting hole 61 and fitting the respective locking pins 59 into the respective locking holes 92 (see FIG. 1).

On the other hand, the holding member 20 is movable in the front-rear direction in gap ranges between the lower end part and the front and rear surfaces of the recess 56 and in gap ranges between the protrusions 27 and the hole surfaces of the retaining holes 57 (see FIGS. 1 and 9). Thus, the configuration of this embodiment can prevent the application of an excessive stress to connected parts of the board connecting portions 12 and the electrically conductive portions 91.

With the intermediate unit 80 held on the first housing member 51, a front part of the circuit board 90 is arranged on the bottom wall 53 of the first housing member 51. The respective partition walls 58 are arranged between the respective electrically conductive portions 91 of the circuit board 90.

Subsequently, the second housing member 52 is mounted to be put on the first housing member 51 from above as shown in FIGS. 7 and 8. The respective lock portions 64 are resiliently fit into the lock holes 75 of the respective lock pieces 67. Further, the respective ribs 65 are resiliently fit into the groove portions 76 of the respective holding pieces 68. In this way, the second housing member 52 is held on the first housing member 51 with separation restricted. Further, the second housing member 52 approaches the first housing member 51 obliquely downward from behind and a position shift of the front end of the second housing member 52 is restricted by the respective inserting portion 74 being fit into the respective insertion holes 62.

In the above way, the connector in which the circuit board 90, the respective terminal fittings 10, the holding member 20 and the housing 50 (first housing member 51 and second housing member 52) are integrally assembled is formed as shown in FIG. 8. The holding member 20 is held in a state vertically sandwiched between the first and second housing members 51, 52 as shown in FIG. 1. The respective terminal fittings 10 are held in a state collectively positioned by the holding member 20 in the housing 50. Thus, when the housing 50 is connected to the unillustrated mating housing, the unillustrated mating terminals are properly electrically connected to the terminal fittings 10 via the tab insertion holes 23.

As described above, since the plurality of terminal fittings 10 are reflow-connected to the circuit board 90 while being held in the holding member 20 according to this embodiment, the respective terminal fittings 10 can be prevented from being relatively shifted in position in the front-rear direction in the reflow step. Thus, the tip positions of the respective terminal fittings 10 are properly maintained in the housing setting step. Since the relative positions of the respective terminal fittings 10 are collectively aligned by the holding member 20 in the case of this embodiment, it is not necessary to strictly manage a relative positional relationship of the respective terminal fittings 10 and workability can be improved.

Since the holding member 20 is made of the material higher in heat resistance than the housing 50 (first housing member 51 and second housing member 52), the holding member 20 can withstand heating in the reflow step.

Further, since the body portions 11 of the respective terminal fittings 10 are held in front of the board connecting portions 12 in the holding member 20, the presence of the holding member 20 does not hinder the reflow connection of the board connecting portions 12 to the circuit board 90. Moreover, the enlargement of the holding member 20 can be avoided. Furthermore, since the holding member 20 is held between the first and second housing members 51, 52, a special member for holding the holding member 20 in the housing 50 is not necessary and an overall structure is not complicated.

### Other Embodiments of Present Disclosure

The embodiment disclosed this time should be considered illustrative in all aspects, rather than restrictive.

Although the circuit board is a flexible printed board in the case of the above embodiment, the circuit board may be a rigid circuit board as another embodiment.

Although the housing is dividable into the first housing member and the second housing member in the case of the above embodiment, the housing may be an integral single member as another embodiment. If the housing is a single member, the holding member may be configured to be inserted into an insertion region of the housing.

Although the first and second housing members are made of the same material in the case of the above embodiment, the first and second housing members may be made of different materials as another embodiment. In this case, the holding member may be made of a material higher in heat resistance than the materials constituting the first housing member and the second housing member.

### LIST OF REFERENCE NUMERALS

10 . . . terminal fitting
11 . . . body portion
12 . . . board connecting portion
20 . . . holding member
21 . . . cavity
22 . . . front wall portion
23 . . . tab insertion hole
24 . . . locking projection
25 . . . opening
26 . . . step
27 . . . protrusion
28 . . . projecting wall
50 . . . housing
51 . . . first housing member
52 . . . second housing member
53 . . . bottom wall
54 . . . front wall
55 . . . side wall
56 . . . recess
57 . . . retaining hole
58 . . . partition wall
59 . . . locking pin
61 . . . fitting hole
62 . . . insertion hole
63 . . . recess
64 . . . lock portion
65 . . . rib
66 . . . covering wall
67 . . . lock piece
68 . . . holding piece
69 . . . body wall
71 . . . lock arm
72 . . . extending wall
73 . . . crossing wall
74 . . . inserting portion
75 . . . lock hole
76 . . . groove portion
80 . . . intermediate unit
90 . . . circuit board
91 . . . electrically conductive portion
92 . . . locking hole

What is claimed is:

1. A connector, comprising:
a plurality of terminal fittings;
a holding member configured such that the plurality of terminal fittings are arranged in parallel therein;
a circuit board, the plurality of terminal fittings being connected to the circuit board; and
a housing for holding the holding member,
the holding member including a plurality of cavities arranged in parallel and a front wall portion closing front ends of the plurality of cavities, and
the plurality of terminal fittings being inserted into the plurality of cavities and having front and rear positions thereof aligned by abutting on the front wall portion.

2. The connector of claim 1, wherein:
the terminal fitting includes a board connecting portion to be connected to the circuit board and a tubular body portion arranged forward of the board connecting portion, and
the holding member holds the body portion in front of the board connecting portion.

3. The connector of claim 1 or 2, wherein:
the housing includes a first housing member and a second housing member, and
the holding member is sandwiched and held between the first housing member and the second housing member.

4. The connector of any one of claims 1 to 3, wherein the holding member is made of a material higher in heat resistance than the housing.

5. A connector manufacturing method for the connector of any one of claims 1 to 4, comprising:
an arranging step of arranging the plurality of terminal fittings in parallel in the holding member;
a reflow step of reflow-connecting the plurality of terminal fittings to the circuit board; and
a holding step of holding the holding member in the housing,
the steps being successively performed.
